(19) United States
(12) Patent Application Publication
(10) Pub. No.: US 2002/0073241 A1
(43) Pub. Date: Jun. 13, 2002

(54) Global signaling memory

(75) Inventors: Harry M. Gilbert, Portage, MI (US); Robert B. Karmes, Delton, MI (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 09/841,857

(22) Filed: Apr. 25, 2001

Related U.S. Application Data
(60) Provisional application No. 60/227,300, filed on Aug. 24, 2000.

(51) Int. Cl. G06F 9/46

(52) U.S. Cl. 709/312

(57) ABSTRACT

A method and system for sharing a common data set between a plurality of computer applications uses a shared data set containing two or more data elements. A first computer software application performs a storage operation to a data element within the data set, and the data set provides a signal to a second software application. The system may also include the delivery of acknowledgment signals back to the first software application. Also optionally, the data set may provide the signal to a plurality of software applications.

### CLAIM OF PRIORITY

This application claims priority to U.S. provisional patent application Ser. No. 60/227,300, filed Aug. 24, 2000, which is incorporated herein by reference in its entirety.

### FIELD OF THE INVENTION

The present invention is generally related to the field of computer software. More particularly, the present invention relates to a method and system for data analysis in which a common data set is shared by multiple software applications, such as data analysis and management applications, to perform multiple functions on the common data set, and the data set is capable of automatically signaling one or more of the applications in response to a change in an element of the data set.

### BACKGROUND OF THE INVENTION

For years, software developers have sought to minimize the amount of memory required to store data associated with various software applications. Thus, shared memory is a well-established concept in computer software systems. Even early software systems often allowed concurrently-running applications to declare portions of their memory to be shared.

Examples of such prior shared memory systems are described in U.S. Pat. No. 5,617,537, to Yamada et al.; U.S. Pat. No. 5,446,841, to Kitano et al.; and U.S. Pat. No. 5,918,229, to Davis et al.

The use of shared memory would be particularly useful in the field of computer-implemented and/or assisted diagnostic equipment. One type of such diagnostic equipment is an engine analyzer, such as the type that would be used to diagnose problems with a vehicle's internal combustion engine. An engine analyzer uses multiple collecting devices to collect diagnostic data from an engine. For example, an engine analyzer for an automobile engine may use several probes to determine certain engine characteristics while the engine is running, such as rotations per minute (RPM), volts, amps, fuel usage, etc. An example of such a prior engine analyzer is shown in U.S. Pat. No. 5,245,324, to Jonker et al. If an engine analyzer were available that permitted multiple software applications to use a common set of data when the data is collected from an engine, the usefulness of the engine analyzer would be greatly increased.

However, prior art shared memory systems contain several disadvantages which limit or reduce the desirability of their application to engine analyzers and other diagnostic equipment. For example, the prior art shared memory systems require each software application that shares the memory to “poll,” or request, data updates or other information from the shared memory. The polling takes place periodically, and each instance of polling interrupts the application's processing tasks, causing inefficient operation and reducing operation speed. In addition, the polling requirement prohibits instantaneous response to or processing of changes to the shared memory data set. Thus, under the prior art shared memory systems, applications requiring a continuous or near-continuous stream of data, such as waveform displays, were either not compatible with the memory systems or produced undesirable results. In addition, the prior art shared memory systems do not facilitate communication between the applications that share the memory.

### SUMMARY OF THE INVENTION

It is therefore a feature and advantage of the present invention to provide an improved shared memory method and/or system.

It is another feature and advantage of the present invention to provide a shared memory method and/or system that automatically signals one or more of the applications sharing the memory when there is a relevant change in the shared memory data set.

It is another feature and advantage of the present invention to provide a shared memory method and/or system that allows improved speed of operation by the applications that share the memory.

It is another feature and advantage of the present invention to provide a shared memory method and/or system that works with applications that require a continuous or near-continuous stream of data.

It is another feature and advantage of the present invention to provide a shared memory method and/or system that allows communication between the applications that share the memory.

The above and other features and advantages are accomplished through a novel shared memory system and method as herein disclosed. A shared memory is implemented on any memory device as a freestanding data set, sharable by any number of concurrently running programs. In a preferred embodiment, a single data set is used, and the data set comprises any number of data elements. Optionally, multiple data sets may be used. Each data set may be shared by multiple software modules. Each data element in each data set has a defined purpose or represents a defined element.

The software modules or programs may receive data from the data set through one or more software interface objects. Each interface object is associated with a specific data element in a specific data set, although the association between a particular interface object and a particular data element may be changed. Each software module or program may select, via an interface object or objects, which data element or elements it is interested in. When a data element is modified, a signal is sent to each software component which has expressed an interest in that data element.

Software components may also optionally poll data elements whether or not they are signaled.

In a preferred embodiment, the present invention is a computer-assisted method of facilitating communication between a plurality of computer software applications using a shared data set containing a plurality of data elements. The method includes the steps of performing a storage operation from a first computer software application to a first data element within the data set, and providing a second computer software application with a signal responsive to the delivery of the storage operation. Optionally, the method comprises the additional steps of storing, from the second application to the first data element, an acknowledgment responsive to the signal, and delivering, from the first data element to the first application, a response corresponding to the acknowledgment. Optionally, the first application may not require a response, or the method may include prohibiting the first application from receiving a response.

Optionally, the method also includes the additional steps of identifying at least one additional computer software application that is in communication with the data set, and delivering the signal to one of the additional computer software applications. Optionally, the method also may be such that identifying information relating to the second computer software application is not required by the first computer software application. Also optionally, the delivering step and the providing step may be performed at a data transfer rate that is substantially equal to the highest data transfer rate available to any computer software application that is in communication with the data set.

Also optionally, the first data element may contain reference to another data element whose name, data or other attributes relate to but differ from the attributes of the first data element. For example, a first data element may contain a variable value, while the other data element may have a constant name which represents a unit of measure for the variable value such as “millivolts” or “KOhms” Also optionally, the first data element may contain a linkage reference to another data element, for the purpose of expressing a grouping relationship between the data elements. Such linkage permits, but is not limited to, the grouping of data elements into a linked list, thus providing a serialized relationship between any number of data elements. Such linkage also permits, but is not limited to, additional attributes or data to be associated with the first data element.

As an additional option, the data set may be copied, revised, or deleted by a user.

The present invention also relates to a computer-readable carrier, such as a computer program product, storing computer instructions therein for sharing data between a plurality of computer applications. The instructions instruct a computing device to perform the steps, and optionally the optional steps, described above.

There has thus been outlined, rather broadly, the important features of the present invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed in this document are for the purpose of description and should not be regarded as limiting. As such, those skilled in the art will appreciate that the conception, upon which this disclosure is based, may readily be used as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a computer of a type suitable for implementing and/or assisting the implementation of the processes described herein;

FIG. 2 illustrates a preferred embodiment of the operation of the notification features of the present invention;

FIG. 3 illustrates an example of how one application may communicate with another application via shared memory in the present invention;

FIG. 4 illustrates how present invention may permit one application to communicate with multiple applications that share the common data set; and

FIG. 5 describes how the present invention may allow a data user and data provider to interact via a shared memory.

### NOTATIONS AND NOMENCLATURE

The detailed description that follows may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to an apparatus for performing these operations. This apparatus may be specially constructed for the required purpose or it may comprise a general purpose computer as selectively activated or reconfigured by a computer program stored in a computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

In this document, the terms “notify” and “notification” are used interchangeably with, and are intended to have the same meaning as, the terms “signal” and “signaling”, respectively.

### DETAILED DESCRIPTION OF PREFERRED EMBODIMENTS OF THE INVENTION

The present invention relates to a novel global signaling memory (GSM) system and method. GSM is a computer assisted and/or implemented system designed to allow multiple applications, such as software programs, algorithms, scripts or other computer-implemented and/or assisted applications, to share data that is stored in a shared memory location or locations.

In a preferred embodiment, a single data set is stored in a single memory location, although multiple data sets and multiple memory locations are optional and possible. Each shared data set contains any number of data elements, and each data element has a defined purpose or represents a defined item. The number of data elements contained within a data set is limited only by the size of the memory. Each data set may be shared by an unlimited number of applications.

An exemplary data set layout for use in the present invention includes a header and any number of data elements, as represented in the following exemplary chart:

Overall Dataset Layout

Dataset Header
Data Element 1
Data Element 2
. . .
Data Element n

The header contains information that is applicable to all elements of the data set, such as the size of the data set and a “read only” flag which, if activated, will “freeze” the data set by prohibiting data updates for a period of time. These and other exemplary items of information for a header are represented in the following exemplary chart:

Dataset Header

Size of dataset
Offset of the first element position in the dataset
Offset of the next available element position in the dataset
Read-only flag - interface software will not change values if this
flag is set
Runtime reference count of users who want to be signaled
Number of signal maps in each element
Unused space
Addresses of users who want to be signaled

Each of the individual header elements illustrated in the chart are in fact optional, and the chart is only intended to illustrate exemplary elements of an appropriate data set header.

A typical data element will contain several attributes, or informational components. For example, a data element may include: an element name; information representative of the size or dimension of the element; user-defined information or actions such as a command or status element; and one or more links to other elements. These and other exemplary items of information for a data element are represented in the following chart:

Data Element Layout

| Name | Description |
|---|---|
| Size | Size of entire element |
| Element Name | Name of element |
| Dim 2 Size | 2^{nd} dimension size |
| Dim 1 Size | 1^{st} dimension size |
| Element Size | Size of each array unit, in bytes |
| Type | User-defined information |
| Extra | User-defined information |
| Command | User-defined “Command” |
| Status | User-defined “Status” |
| Data Size | User-defined information on running data size |
| Units index | Relative index of another element to serve |
| | as a unit-of-measure label for the current |
| | element |
| Link | Relative link to another element. Add to |
| | current position to get new position. User- |
| | defined usage |
| Notify Map | Offset in the element where the signaling maps |
| | can be found |
| Data | Data area |
| Notify Maps | Signaling maps for the notification process |

Each of the informational components illustrated in the above chart are in fact optional, and the chart is only intended to illustrate exemplary informational components of a data element. Optionally, each data element may contain an initial value, or it may wait for input from a software application.

In the embodiment wherein at least one data element contains a link to another data element, the user may provide for relationships between data elements. Such linkage may permit or express, but is not limited to, the grouping of data elements into a linked list, thus expressing a serialized relationship between any number of data elements. Such linkage also permits, but is not limited to, the association of additional attributes or data contained within a second data element, with the first data element.

The software implementation of GSM requires a multi-tasking computer operating system that is capable of supporting a platform wherein common memory may be shared between independent, concurrently-running software applications or algorithms, and wherein messages may be sent between the applications. Preferably, the present invention is implemented on a computer that is running a Microsoft Windows-based operating system, such as Windows NT, 95, 98, 2000, ME, or XP. However, GSM may also be implemented on computing devices equipped with other operating systems, such as a Linux, or Mac OS based operating system.

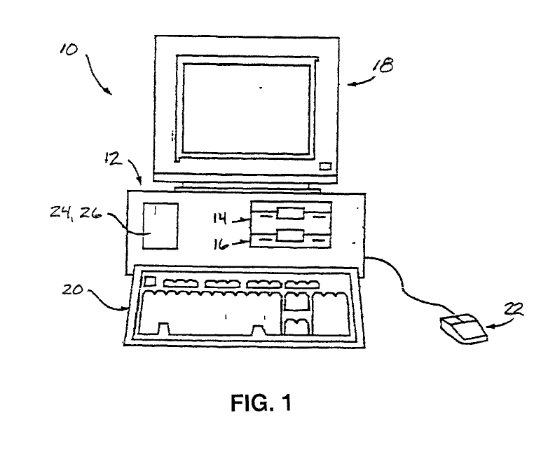

FIG. 1 illustrates a computer of a type suitable for carrying out the present invention. Viewed externally, the conceptual computer system 10 in FIG. 1 has a central processing unit 12 having optional disk drives 14, 16. Disk drive indications 14, 16 are merely symbolic of a number of disk drives which might be accommodated by the computer system. Typically these would include a floppy disk drive 14, a hard disk drive (not shown externally), and a CD ROM, CD-R, CD-RW, digital video disk (DVD), ZIP drive or other memory storage device 16. The number and type of drives varies, typically with different computer configurations. Disk drives 14, 16 are in fact optional, and for space considerations, may easily be omitted from the computer system used in conjunction with the processes described herein.

The computer also has an optional display 18 upon which information is displayed. In some situations, a keyboard 20 and a mouse 22 may be provided as input devices to interface with the central processing unit. Then again, for enhanced portability, the keyboard 20 may be either a limited function keyboard or omitted in its entirety. In addition, the mouse 22 may instead be a touch pad control device, or a track ball device, or a pointing or other input device such as a wireless communication device, or even omitted in its entirety as well. In addition, the computer system also optionally includes at least one infrared transmitter 24 and/or infrared receiver 26 for either transmitting and/or receiving infrared signals, one example of wireless transmission and/or reception. The exemplary computer illustrated in FIG. 1 is an optional embodiment representing a desktop personal computer. However, any computing device, such as a laptop, a hand-held computer, a server, or even a piece of diagnostic equipment having computer processing and memory attributes, such as an engine analyzer, may be used.

One skilled in the art will recognize that several methods exist wherein software applications may share one or more common memory locations. For example, Microsoft Windows uses a shared memory referred to as a dynamically linked library (DLL), wherein a library of files, or data sets, is shared by multiple applications. Each data set may be modified by only one of the applications, but each application may read any of the data sets. Each application will periodically “poll” any of the data sets of interest in the DLL to obtain data elements from the data set or to determine whether any data elements within the data set have been modified.

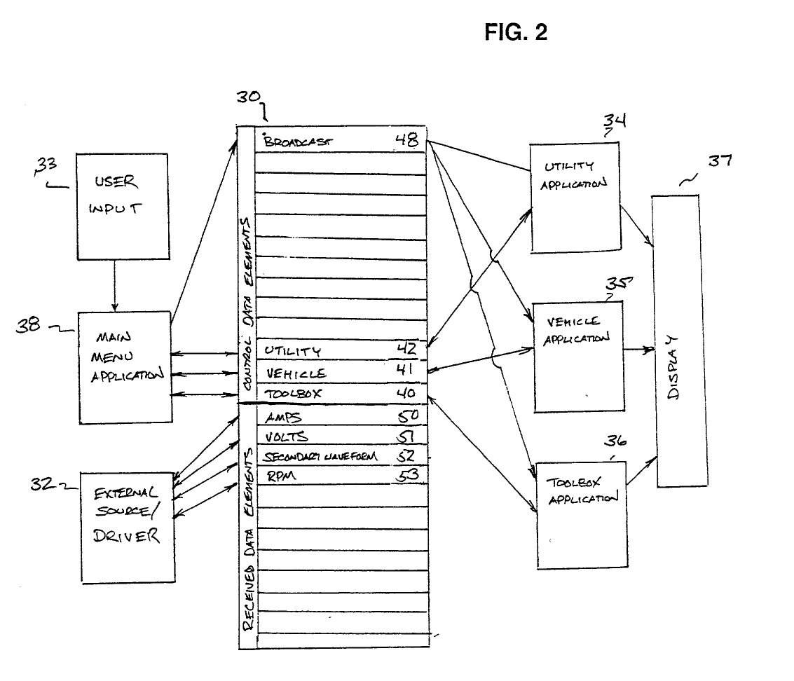

As explained above, such prior art shared memory systems are not desirable for applications such as diagnostic software because each application may only receive new data or relevant notifications by polling one or more of the elements in the data set. The present invention overcomes the deficiencies of the prior art by providing a shared memory system wherein an application is notified upon the occurrence of a relevant event, such as the modification of a data element that is of interest. FIG. 2 illustrates a preferred embodiment of the shared memory system that provides such notification to applications that share the memory. A data set 30 containing data elements receives data from one or more external sources 32. The data elements include control data elements such as those identified as 40-42 and 48 and received data elements such as those identified as 50-53. The classification of data elements as control data elements and received data elements is only for the purpose of distinguishing how they are used in this example, as all data elements preferably have similar or identical functions, regardless of how they may be used in connection with a particular application.

The external source 32 is typically a device containing a driver that collects data, such as a vehicle engine analyzer or other diagnostic tool. Optionally, the external source may be, or an additional external source may also be, a user input device 33 such as a keyboard, mouse, wireless communication device, or pointing device. A further external source or sources may be one or more of the applications 34-36 themselves. The situation of applications serving as external sources is preferable, and it is required in the GSM embodiment which facilitates communication between applications (described below).

FIG. 2 illustrates an exemplary system in which a main menu application 38 controls worker applications 34, 35, 36 which all share the same display area 37.

Each worker application preferably has at least one corresponding control data element for communication between itself and the main menu application. For example, FIG. 2 illustrates a system wherein the toolbox application 36 has a corresponding toolbox control data element 40. The main menu application 38 notifies a worker application such as the toolbox application 36 through the application's corresponding control data element 40 with a storage operation, such as the placement of a value into the data element, indicating that some action should be taken. For example, the main menu application 38 may place a command value in the toolbox control data element 40 indicating that the user input 33 has requested that the toolbox application 36 become active and visible on the display 37. The toolbox control data element 40 notifies the toolbox application 36 of the command value received from the main menu application 38. The toolbox application 36 responds by becoming visible on the display 37. The toolbox application 37 then acknowledges the request by placing an appropriate status value in the toolbox control data element 40, which in turn notifies the main menu application 38 of the status.

Continuing the example, the toolbox application 36 may also signal the amps received data element 50 that it desires to receive data relating to amps whenever that data is revised. Thereafter, the amps received data element 50 will notify the toolbox application 36 whenever the amps received data element 50 is revised by an external source or driver 32. The toolbox application 36 need not initiate any further notifications to the amps received data element 50 unless the toolbox application 36 desires to stop receiving data relating to amps. Each additional application will work with its corresponding control data element in the manner described above.

Optionally and preferably, the data set 30 will include control data elements that are shared among multiple applications. For example, a broadcast, or general purpose, control data element 48 may be used to notify some or all applications of changes to the data set that are of general interest. In such a situation, the user input 33 may consist of, for example, a command to stop receiving updates so that the user has time to review or analyze a snapshot of data at a particular time. In such a case, the broadcast control data element 48 will notify some or all applications that they are to stop accepting updated data until further notice. As another example, the user input 33 may consist of a command to shut down all programs. In such a case, the broadcast control element will notify all applications that the applications are to shut down. Note that the labels used in FIG. 2 for the applications and data elements, such as “toolbox”, “vehicle”, “amps”, etc. are only exemplary labels for an exemplary embodiment of the present invention as used with a vehicle engine analyzer. Any appropriate label, application or data element may be used.

Optionally, the data received by the received data elements 50-53 from the external sources 32 and 33 may be stored in a memory storage device such as a memory chip or a hard drive, CD-ROM, CD-R, CD-RW, or floppy disk. However, such storage is optional and is not required to implement the present invention.

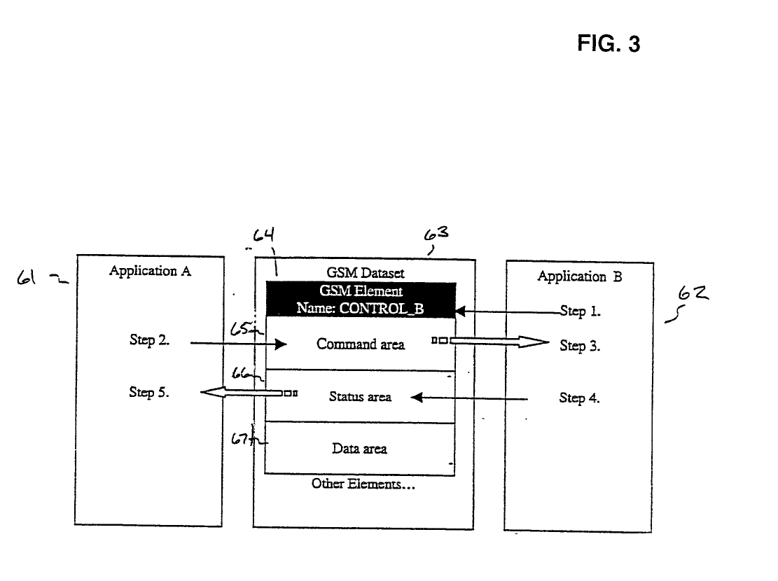

The present invention may also facilitate communication between applications that share the common memory. FIG. 3 illustrates a functional example of how such communication may occur. Two applications 61 and 62 share a common data set 63. The data set contains one or more data set elements such as 64, and each data set element contains at least three components: a command area 65 used by the application making a request, a status area 66 used by the application acknowledging the request, and a data area 67 which contains the actual data which the data element is to represent, if any. Each of the three areas—command, status and data—can notify an application when the area's value is set or modified. The above-described components and labels for each data element are only intended to be illustrative, and are not intended to limit the scope of the present invention.

Application B 62 first registers with its corresponding control data element that it wishes to be notified of changes in the data set element that is labeled as CONTROL_B 64. When application A 61 places a value in the command area 65 of data element CONTROL_B, application B 62 is signaled that the command area 65 has been changed. Application B 62 accepts the command, performs some action that is responsive to the command, and responds by placing a value in the status area 66 of CONTROL_B. Application A 61 is then signaled of the change in the status area 66 of CONTROL_B.

The storage of data into and retrieval of data from data elements preferably occurs at the speed of basic memory storage-and-retrieval operations in a given computer system. In other words, the storage and retrieval preferably occur at the highest data transfer rate available to any application within the computer system.

This facilitates real-time interaction between multiple applications in a computer system, whether for sharing data from high speed data communications, signals from measurement devices, user input, and other types of data. Signaling preferably occurs at the rate of message transmission by the computer's operating system. This is the rate at which operating systems with messaging, such as Microsoft Windows, Mac OS, and certain other applications, communicate with applications for all graphical events and user input events.

The communication between applications in the present invention is a non-blocking type of communication. That is, when one application speaks to a data element by putting data into the data element, that data element signals all applications that are listening to, or receiving data from, the element at the time. This non-blocking feature permits the “speaking” application to proceed without waiting for the “listening” applications to receive, acknowledge, or respond to the signals.

In addition, any application sharing the common memory preferably can have access to any data set and data element at any time, without revealing its identity or needing any requirements of identity. This feature permits applications to be developed at different times while still being permitted to fully participate in the data sharing and signaling. For example, applications which serve simply as surrogate applications for design and debugging purposes may use this feature. The feature also facilitates “listening post” applications for monitoring activity between applications, as well as “meta” applications which can control whole groups of applications through global signaling.

Each GSM data set is a self-contained group of data elements representing a memory model. Any number of GSM data sets can co-exist and be shared at a given time, each representing its own memory model. When a GSM data set ceases to be used by any running application, it is preferably saved from its location in computer memory to its location on a computer permanent storage device, retaining the most recent values in its GSM data elements. Further, an application can interact with any number of GSM data sets and with any number of GSM data elements at a given time, limited only by the size of the computer memory and operating system capacity.

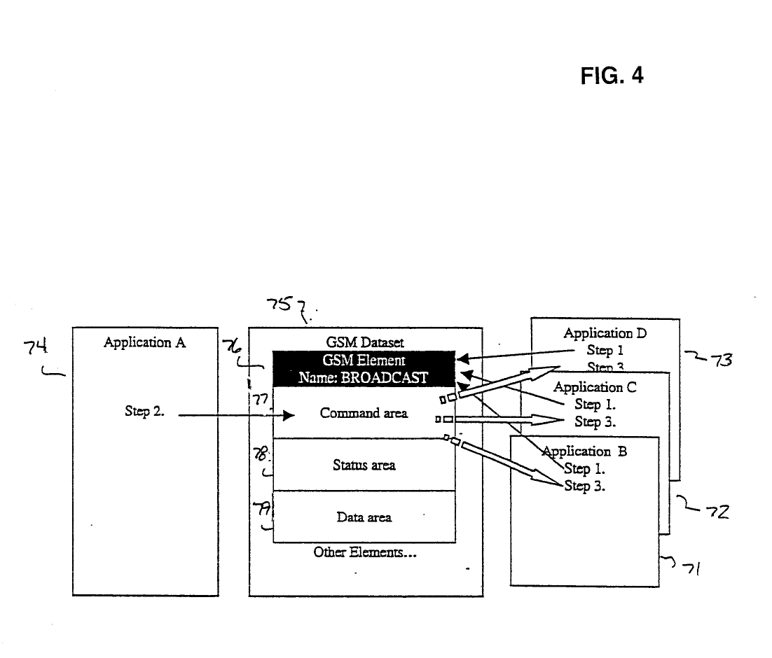

FIG. 4 illustrates how the broadcast option of the present invention may permit one application to communicate with multiple applications that share the common data set. Any number of the multiple applications, as represented by 71-73, may register of a desire to be notified of changes to the broadcast data element 76. In the example shown in FIG. 4, application A 74 places a value in the command area 77 of the broadcast data element. Thereafter, applications B-D 71-73 are automatically notified that the command area 77 of the broadcast data element has changed. The applications receive the notification and take appropriate action in response to the notification.

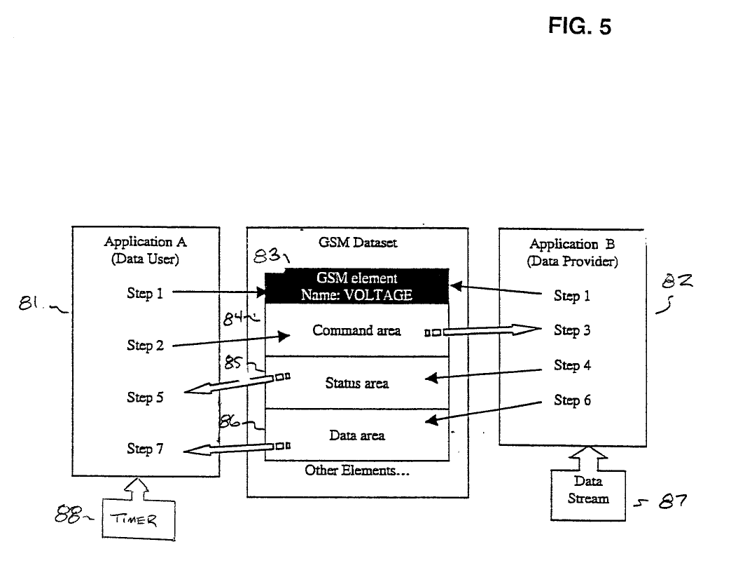

FIG. 5 describes how the present invention may allow a data user and data provider to interact via a shared memory. A user application 81 and a data provider application 82 each register to be signaled by a change in a data element 83, in this example the data set element being that which is representative of voltage. When the user requests data relating to voltage, user application 81 places a value in the command area 84 of the data element 83 indicating a request for data. Data provider application 82 is automatically signaled of the request and retrieves the request from the command area 84 of the data element 83. Data provider application 82 acknowledges receipt of the request by placing a value in the status area 85 of the data element, and user application 81 is automatically notified of the acknowledgment. Data provider application 82 then retrieves data, such as a measured voltage, from an external source such as a data stream 87 and places a value representative of such data in the data area 86 of the data element 83. User application 81 is then automatically signaled of the placement of data into the data area 86 of the data element 83. Data provider application 82 then continues to retrieve data from the data stream 87 and deliver it to the data area 86, and data area 86 continues to notify user application 81 of its receipt of new data until an event occurs, such as if the user application 81 alerts the command area 84 that it no longer wishes to receive new data.

In some situations, the user may not desire that an application receive new data each time that it becomes received. For example, if a diagnostic tool provides a stream of quickly-changing data, and an application provides a digital display of such data, the user may desire to slow the display of such data, or to limit the updating of the data to certain time intervals, in order to provide a display that is easier for the human eye to read.

The alternate embodiment in FIG. 5 that illustrates a timer 88 is representative of such a situation. A user application 81 and a data provider application 82 each register to be signaled by a change in a data element 83, in this example the data set element again being that which is representative of voltage. When the user requests data relating to voltage, user application 81 places a value in the command area 84 of the data element 83 indicating a request for data. Data provider application 82 is automatically signaled of the request and retrieves the request from the command area 84 of the data element 83. Data provider application 82 acknowledges receipt of the request by placing a value in the status area 85 of the data element 83, and user application 81 is automatically notified of the acknowledgment. Data provider application 82 then retrieves data, such as a measured voltage, from an external source such as a data stream 87 and places a value representative of such data in the data area 86 of the data element 83. However, unlike the scenario described above which does not use a timer, here user application 81 only retrieves data from the data area 86 of the data element by polling the data element periodically upon receipt of a signal from a timer application 88. Data provider application 82 continues to retrieve data from the data stream 87 and deliver it to the data area 86, and user application 81 continues to retrieve data in response to the timer application 88, until an event occurs, such as if user application 81 alerts the command area 84 that it no longer wishes to receive new data.

GSM is preferably implemented as a software object, referred to herein as the “GSM Object,” that partners with one or more software applications to create the GSM environment. A GSM Object preferably provides all functions to implement the GSM environment, including but not limited to one or more of functions to create, destroy, control access to, and modify a data set, as well as to signal (i.e., send messages to) other GSM Objects.

In a typical environment using GSM, each participating application may host an unlimited number of GSM Objects. Each GSM Object can create, access, and/or destroy any data set, as well as provide access to any data element in a data set.

Therefore, the number of GSM Objects in each environment is a matter of preference for the software designer. For example, multiple GSM Objects may be used, with each GSM Object permanently dedicated to a single data element in a single data set. Alternatively, for example, a single GSM Object may be used for all data elements, with the GSM Object being directed to whichever data set or data element is relevant at the time of the direction.

The above embodiments are only to be construed as examples of the various different types of global memory systems that may be utilized in connection with the computer assisted and/or implemented process of the present invention.

The many features and advantages of the invention are apparent from the detailed specification. Thus, it is intended by the appended claims to cover all such features and advantages of the invention that fall within the true spirit and scope of the invention. Further, since numerous modifications and variations will readily occur to those skilled in the art, it is not desired to limit the invention to the exact construction and operation illustrated and described. Accordingly, all suitable modifications and equivalents may be resorted to, falling within the scope of invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer-assisted method of facilitating communication between a plurality of computer software applications, comprising the steps of:
performing a storage operation from a first computer software application to a first data element included within a data set, wherein the data set is shared by a plurality of computer software applications, the plurality of computer software applications comprising at least the first computer software application and a second computer software application; and
providing the second computer software application with a signal responsive to the storage operation.

2. The method of claim 1, comprising the additional steps of:
storing, from the second computer software application to the first data element, an acknowledgment responsive to the signal; and
delivering, from the first data element to the first computer software application, a response corresponding to the acknowledgment.

3. The method of claim 1, comprising the additional step of storing, from the second application to the first data element, an acknowledgment responsive to the signal, and wherein a response corresponding to the acknowledgement is not delivered to the first application.

4. The method of claim 1, comprising the additional steps of identifying at least one additional computer software application that is in communication with the data set and delivering the signal to the at least one additional computer software application.

5. The method of claim 1, wherein identifying information relating to the second computer software application is not required by the first computer software application.

6. The method of claim 1, wherein the delivering step and the providing step are performed at a data transfer rate that is substantially equal to the highest data transfer rate available to any computer software application that is in communication with the data set.

7. The method of claim 1, wherein the first data element is representative of a name, a dimension, a size, a command, a status, or a link.

8. The method of claim 1, wherein the first data element corresponds to a link to a second data element, each of the data elements includes attributes, and the attributes of the second data element relate to and differ from the attributes of the first data element.

9. The method of claim 1, wherein the first data element corresponds to a link to a second data element, and wherein the link establishes a relationship between the data elements as members of a group.

10. The method of claim 1 wherein the data set is capable of being copied, revised, or deleted by a user.

11. A computer-readable carrier containing computer instructions therein for sharing data between a plurality of computer applications, the instructions including:
performing a storage operation from a first computer software application to a first data element included within a data set, wherein the data set is shared by a plurality of computer software applications, the plurality of computer software applications comprising at least the first computer software application and a second computer software application; and
providing the second computer software application with a signal responsive to the storage operation.

12. The computer-readable carrier of claim 11, the carrier further including instructions for delivering, from the second application to the first data element, an acknowledgment responsive to the signal, and delivering, from the first data element to the first application, a response corresponding to the acknowledgment.

13. The computer-readable carrier of claim 11, the carrier further including instructions for the steps of identifying at least one additional computer software application that is in communication with the data set and delivering the second signal to the at least one additional computer software application.

14. The computer-readable carrier of claim 11, wherein the carrier further includes instructions that direct the delivering step and the providing step to be performed at a data transfer rate that is substantially equal to the highest data transfer rate available to any computer software application that is in communication with the data set.

15. The computer-readable carrier of claim 11, wherein the carrier further includes instructions for directing the first data element to be representative of a name, a dimension, a size, a command, a status, or a link.

16. The computer-readable carrier of claim 11, wherein the carrier further includes instructions for directing the first data element to correspond to a link to a second data element, each of the data elements includes attributes, and the attributes of the second data element relate to and differ from the attributes of the first data element.

17. The computer-readable carrier of claim 11, wherein the carrier further includes instructions for directing the first data element to contain a link to a second data element, and the link establishes a relationship between the data elements as members of a group.

18. The computer-readable carrier of claim 11, wherein the carrier further includes instructions for permitting the data set to be copied, revised, or deleted by a user.

19. A system for facilitating communication between a plurality of computer software applications, comprising:
means for performing a storage operation from a first computer software application to a first data element included within a data set; and
means for providing the second computer software application with a signal responsive to the storage operation;
means for delivering an acknowledgment responsive to the signal to the first data element; and
means for delivering, to the first computer software application, a response corresponding to the acknowledgment;
wherein the data set is shared by a plurality of computer software applications, the plurality of computer software applications comprising at least the first computer software application and the second computer software application.
